(19) United States
(12) Patent Application Publication
(10) Pub. No.: US 2026/0056643 A1
(43) Pub. Date: Feb. 26, 2026

(54) METHOD OF OUTPUTTING HOME SCREEN BASED ON CATEGORY OF APPLICATIONS OF ELECTRONIC DEVICE AND DEVICE FOR PERFORMING THE METHOD

(71) Applicant: Samsung Electronics Co., Ltd., Suwon-si (KR)

(72) Inventors: Changdo KIM, Suwon-si (KR); Sangheon KIM, Suwon-si (KR); Eunkyung KIM, Suwon-si (KR); Jeongseob KIM, Suwon-si (KR)

(21) Appl. No.: 19/305,168

(22) Filed: Aug. 20, 2025

Related U.S. Application Data
(63) Continuation of application No. PCT/KR2025/011004, filed on Jul. 24, 2025.

(30) Foreign Application Priority Data
Aug. 26, 2024 (KR) 10-2024-0114106
Sep. 26, 2024 (KR) 10-2024-0131187
Jul. 16, 2025 (KR) 10-2025-0095940

(51) Int. Cl. G06F 3/04817; G06F 3/0482; G06F 3/0484; G06F 3/04883

(52) U.S. Cl. CPC G06F 3/04817; G06F 3/0482; G06F 3/0484; G06F 3/04883

(57) ABSTRACT

An electronic device identifies a first area of a target page of a home screen based on a first user input, determines a plurality of applications having icons corresponding to the plurality of applications to be displayed in the first area of the target page of the home screen based on a second user input, obtains an image generated based on first information associated with the first area and second information associated with the plurality of applications, and displays the target page on a display by displaying the icons corresponding to the plurality of applications in the first area and the image in at least a portion of a second area distinct from the first area.

### CROSS-REFERENCE TO RELATED APPLICATIONS

This application is a continuation application of International Application No. PCT/KR2025/011004 designating the United States, filed on Jul. 24, 2025, in the Korean Intellectual Property Receiving Office and claiming priority to Korean Patent Application No. 10-2024-0114106, filed on Aug. 26, 2024, Korean Patent Application No. 10-2024-0131187, filed on Sep. 26, 2024, and Korean Patent Application No. 10-2025-0095940, filed on Jul. 16, 2025 in the Korean Intellectual Property Office, the disclosures of which are incorporated by reference herein in their entireties.

### TECHNICAL FIELD

Embodiments incorporating features of the present disclosure relate to methods of outputting a home screen of an electronic device, and more particularly, to methods of outputting an image and icons of a plurality of applications on a specific page of the home screen.

### BACKGROUND

An electronic device may provide a home screen that outputs icons corresponding to one or more applications so that a user may identify the applications installed on the electronic device. The home screen may include one or more pages, and icons may be arranged on each page. The icons arranged on each page may be rearranged by the user. A wallpaper may be set to the page, and the page may be displayed to show icons on the wallpaper.

The user may individually select applications to be arranged on the page and designate (e.g., touch drag and drop) new positions of the selected applications to change the configuration of the page. Additionally, the user may select the wallpaper to change the configuration of the page, and the selected wallpaper may be set to the page.

### SUMMARY

According to an embodiment, an electronic device may include a display, at least one processor including processor circuitry, and memory including one or more storage media storing instructions, wherein the instructions, when executed individually or collectively by the at least one processor, may cause the electronic device to identify a first area of a target page of a home screen based on a first user input.

According to an embodiment, the instructions, when executed individually or collectively by the at least one processor, may cause the electronic device to determine a plurality of applications based on a second user input, each application associated with a corresponding icon to be displayed in the first area of the target page of the home screen.

According to an embodiment, the instructions, when executed individually or collectively by the at least one processor, may cause the electronic device to obtain an image generated based on first information associated with the first area and second information associated with the plurality of applications.

According to an embodiment, the instructions, when executed individually or collectively by the at least one processor, may cause the electronic device to display a plurality of icons corresponding to the plurality of applications in the first area and the image in at least a portion of a second area distinct from the first area.

According to an embodiment, a method performed by an electronic device may include identifying a first area of a target page of a home screen based on a first user input.

According to an embodiment, the method performed by the electronic device may include determining a plurality of applications based on a second user input, each application associated with a corresponding icon to be displayed in the first area of the target page of the home screen.

According to an embodiment, the method performed by the electronic device may include obtaining an image generated based on first information associated with the first area and second information associated with the plurality of applications.

According to an embodiment, the method performed by the electronic device may include displaying the target page on the display by displaying a plurality of icons corresponding to the plurality of applications in the first area and the image in at least a portion of a second area distinct from the first area.

According to an embodiment, an electronic device may include a display, at least one processor including processor circuitry, and memory including one or more storage media storing instructions, wherein the instructions, when executed individually or collectively by the at least one processor, may cause the electronic device to identify a first area of a target page of a home screen based on a first user input.

According to an embodiment, the instructions, when executed individually or collectively by the at least one processor, may cause the electronic device to determine a plurality of applications based on a second user input, each application associated with a corresponding icon to be displayed in the first area of the target page of the home screen.

According to an embodiment, the instructions, when executed individually or collectively by the at least one processor, may cause the electronic device to display a plurality of icons corresponding to the plurality of applications in at least a portion of the first area, on the display.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram of an electronic device in a network environment, according to an embodiment;

FIG. 2A is a diagram illustrating an artificial intelligence (AI) system, according to an embodiment;

FIG. 2B is a diagram illustrating a configuration of an AI system, according to an embodiment;

FIG. 3 is a flowchart of a method of outputting a target page, according to an embodiment;

FIG. 4A illustrates a method of receiving a first user input and identifying a first area of a target page corresponding to the first user input, according to an embodiment;

FIG. 4B illustrates a first area of a target page and a second area determined based on the first area, according to an embodiment;

FIG. 5 illustrates a method of receiving a second user input, according to an embodiment;

FIG. 6 is a flowchart of a method of receiving a second user input using a user interface (UI) object, according to an embodiment;

FIG. 7 illustrates a method of outputting a UI object based on a first user input and receiving a second user input using the output UI object, according to an embodiment;

FIG. 8 is a flowchart of a method of obtaining a plurality of applications based on a first prompt generated based on a second user input, according to an embodiment;

FIG. 9 illustrates a method of arranging icons corresponding to a plurality of applications in a first area, according to an embodiment;

FIG. 10 is a flowchart of a method of obtaining an image based on a second prompt generated based on first information about a first area and second information about a plurality of applications, according to an embodiment;

FIG. 11 illustrates a method of displaying a target page to include icons and images corresponding to a plurality of applications, according to an embodiment;

FIG. 12 is a flowchart of a method of displaying an image in a second area when a background image is set to a target page, according to an embodiment;

FIG. 13 is a flowchart of a method of displaying an image when a graphic object is displayed in a second area of a target page, according to an embodiment;

FIG. 14 is a flowchart of a method of displaying an additional image in a first area of a target page, according to an embodiment;

FIG. 15 is a flowchart of a method of generating and outputting a target page, according to an embodiment;

FIG. 16 is a flowchart of a method of displaying a target page when the size of the target page is reduced, according to an embodiment;

FIG. 17 illustrates a method of displaying a target page when the size of the target page is reduced from a first size to a second size, according to an embodiment;

FIG. 18 is a flowchart of a method of displaying icons corresponding to a plurality of applications in a first area of a target page, according to an embodiment;

FIG. 19 illustrates a method of displaying icons corresponding to a plurality of applications in a first area of a target page, according to an embodiment;

FIG. 20 illustrates a flowchart of a method of configuring a target page to arrange icons only in an area designated based on a user input, according to an embodiment; and

FIG. 21 illustrates a method of configuring a target page to arrange icons only in an area designated based on a user input, according to an embodiment.

### DETAILED DESCRIPTION

Hereinafter, various embodiments of the present disclosure will be described with reference to the accompanying drawings. However, this is not intended to limit the present disclosure to specific embodiments, and it should be understood that various modifications, equivalents, and/or alternatives of the embodiments of the present disclosure are included.

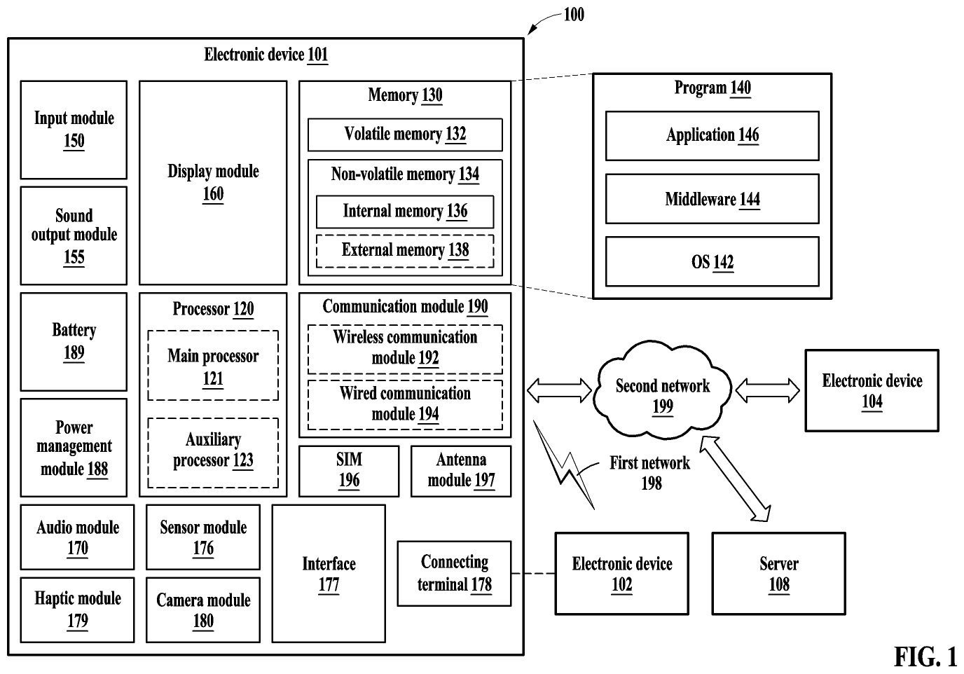

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or communicate with an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an embodiment, as at least part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specialized for a designated function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An AI model may be generated by machine learning. Such learning may be performed, for example, by the electronic device 101 in which an artificial intelligence model is executed, or via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive, from the outside (e.g., a user) of the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to sense a touch, or a pressure sensor adapted to measure the intensity of force incurred by the touch.

The audio module 170 may convert a sound into an electric signal or vice versa. According to an embodiment, the audio module 170 may obtain the sound via the input module 150 or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., vibration or movement), or an electrical stimulus which may be recognized by a user via their tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., a LAN or a wide area network (WAN))). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, by using subscriber information (e.g., international mobile subscriber identity (IMSI)) stored in the SIM 196.

The wireless communication module 192 may support a 5G network after a fourth generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mm Wave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the components described above may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as, or a different type from, the electronic device 101. According to an embodiment, all or some of operations to be executed by the electronic device 101 may be executed by one or more of the external electronic devices 102, 104, or 108. For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to the embodiments disclosed herein may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the item, unless the relevant context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. Terms such as “first,” “second,” “first,” or “second” may be used simply to distinguish one component from another and may not limit the components with respect to other aspects (e.g., importance or order). It is to be understood that if a component (e.g., a first component) is referred to, with or without the term “operatively” or “communicatively”, as “coupled with,” “coupled to,” “connected with,” or “connected to” another component (e.g., a second component), it means that the component may be coupled with the other component directly (e.g., by wire), wirelessly, or via a third component.

As used in connection with embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Embodiments set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not differentiate between where data is semi-permanently stored in the storage medium and where the data is temporarily stored in the storage medium.

According to an embodiment, a method according to embodiments disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smartphones) directly. If distributed online, at least portion of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

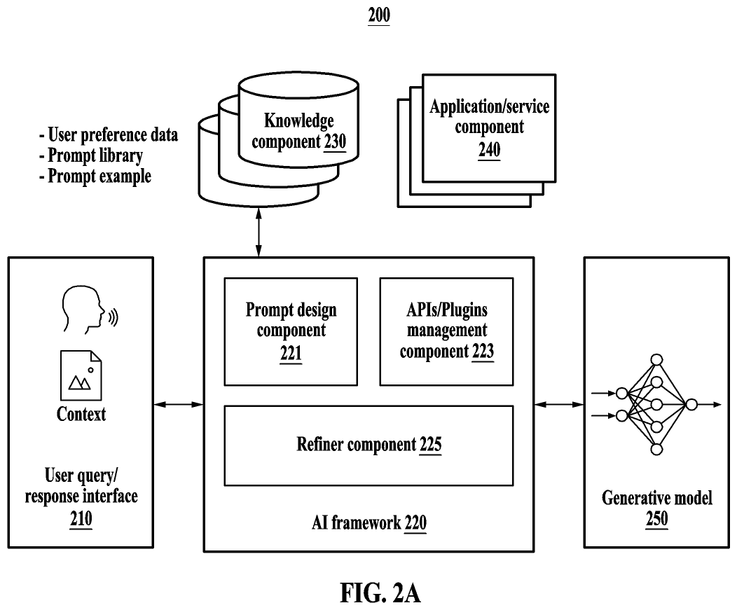

FIG. 2A is a diagram illustrating an artificial intelligence (AI) system, according to an embodiment.

An AI system 200 may include a user query/response interface 210, an AI framework 220, a knowledge component 230, an application/service component 240, and/or a generative model 250.

In the AI system (hereinafter, also referred to as the “system”) 200, the user query/response interface 210 may receive an input. The input may include data obtained or generated by a user input and/or an electronic device (e.g., the electronic device 101 of FIG. 1 or an electronic device 261 of FIG. 2B). The data may include an image, a video, and/or sensor data (e.g., illuminance data around the electronic device, posture data (or orientation data) of the electronic device, an internal temperature of the electronic device (e.g., a temperature of the display module 160 or a temperature of the processor 120) obtained from a sensor or a sensor hub (e.g., auxiliary processor 123), size information about a display area of the display module 160, and/or an image obtained by an image sensor (e.g., included in the camera module 180) of the electronic device) generated by at least one processor (e.g., the processor 120 of FIG. 1 or a processor 270 of FIG. 2B) of the electronic device. For example, the user input may be an input, such as a natural language, touch data obtained by touch circuitry (e.g., used for identifying an input from a finger and/or a stylus) included in the display module 160, an image, audio, and/or a video. In addition, when the user input is transmitted, context information may also be transmitted. The context information may include various pieces of side information related to a time point at which the user input is input to the system 200. For example, the context information may include information about an application currently used by the user (application information) or information about a location of the user (location information). In addition, the user input may be a combination of the natural language, image, audio, video, and/or the context information. In addition, the user input may include a non-natural language input, such as selecting a menu.

The user query/response interface 210 may provide an output of a generative AI system to the user. The output may include a result (or result information) generated or obtained by the system 200 at least partially based on the input. The output may include a natural language-based response and/or specific content. The output may also include an action requested by the user. For example, the output may have a format according to the user settings of the electronic device.

The AI framework 220 may receive a user input. The AI framework 220 may tune and control one or more components required to perform an operation that corresponds to the user's intent, based on the user input (e.g., a query of the user).

The user input received from the user query/response interface 210 may be transmitted to a prompt design component 221. The prompt design component 221 may be used to generate a prompt that is suitable as an input to a generative model (e.g., a large language model (LLM), a large vision model (LVM), and/or a large multimodal model (LMM)) based on the user input.

The prompt design component 221 may be an AI component using a machine learning algorithm or a neural network. The prompt design component 221 may generate an improved prompt by learning over time. The prompt design component 221 may access the knowledge component 230 to generate the prompt based on the user input. The knowledge component 230 may include user preference data, a prompt library, and/or a prompt example. The prompt design component 221 may provide the generated prompt to the generative model (e.g., the LLM, the LVM, and/or the LMM).

An application programming interfaces (APIs)/plugins management component 223 may communicate with an external information source based on a request for additional information when the user input is transmitted to the generative model 250.

The APIs/plugins management component 223 may establish a communication channel to communicate with the outside of the system 200 via an API. The APIs/plugins management component 223 may provide access to various data sources via the communication channel. For example, the APIs/plugins management component 223 may be used to send a request to another component (e.g., the application/service component 240) that provides feedback (or a response) according to the prompt. The obtained information may be used to generate a prompt by the prompt design component 221 together with the user input or may be used as an input to the generative model 250.

When a final action, rather than an intermediate action, needs to be performed by an application or a service in response to the user input, the APIs/Plugins management component 223 may request the final action via the API.

A refiner component 225 may at least partially tune (or adjust) (or change) a result (e.g., content) obtained (or output) from the generative model 250. For example, the refiner component 225 may determine a relevance (e.g., a score) between an output (e.g., content) of the generative model and the user input. For example, the refiner component 225 may determine whether the output includes biased information (e.g., selective information). For example, the refiner component 225 may determine whether the output includes harmful information (e.g., violent content or profanity).

The refiner component 225 may determine a matching level between the output of the generative model 250 and the user input (e.g., the intent of the user input). When the refiner component 225 determines that the output of the generative model 250 does not correspond to the user input, the refiner component 225 may modify the output to correspond to the user input.

The refiner component 225 may provide a hint (e.g., a hint for generating a prompt) to the user to obtain information that corresponds to the user's intent from the generative model 250.

The generative model 250 may be a neural network that generates new data (e.g., text, an image, audio, or a video) based on a user input (e.g., a user utterance). The generative model 250 may include an image generation model and/or a language generation model.

The image generation model may include a generative adversarial network (GAN) and/or a variational autoencoder (VAE). A diffusion-based generative model having the structure of the VAE and the transformer may be an example of the image generation model.

The language generation model (e.g., ChatGPT) may be a model trained to output a statistically most appropriate output based on an input. The language generation model may include the LLM. The LLM may identify various types of inputs, such as text, an image, audio (e.g., voice), and/or a video, and may generate new data corresponding to the input.

In an embodiment, the AI framework 220 and/or the generative model 250 may be included in an AI module (e.g., including processing circuitry) in the electronic device. For example, the AI module may be operatively coupled to at least one processor (e.g., the processor 120 of FIG. 1 or the processor 270 of FIG. 2B) of the electronic device. For example, the AI module may be operatively coupled to a sensor hub of the electronic device for one or more sensors in the electronic device.

FIG. 2B is a diagram illustrating a configuration of an AI system, according to an embodiment.

According to an embodiment, an AI system 260 (hereinafter, also referred to as the “system”) may include an electronic device 261 (e.g., the electronic device 101 of FIG. 1). The electronic device 261 may be a mobile terminal (e.g., a smartphone, a tablet, a laptop, and a wearable device) or a fixed terminal (e.g., a personal computer (PC), a refrigerator, and a television).

According to an embodiment, the electronic device 261 may include at least a portion of the configuration of the electronic device 101 of FIG. 1. The electronic device 261 may include a processor 270 (e.g., the processor 120 of FIG. 1) including processing circuitry. The processor 270 may include at least one processor. The electronic device 261 may include a memory 280 (e.g., the memory 130 of FIG. 1) including one or more storage media storing instructions.

In the system 260, the electronic device 261 may perform a requested AI function (e.g., image generation) using an AI model 290. The AI model 290 may include at least one of the LLM, the LVM, a multimodal model (e.g., a large vision language model (LVLM)). For example, the AI model 290 may include the generative model 250 of FIG. 2A, such as the natural language generation model and the image generation model.

According to an embodiment, an external server (e.g., the server 108 of FIG. 1) or an external electronic device (e.g., the electronic device 102 or 104 of FIG. 1) may include (or store) the AI model 290. The AI model 290 may be embedded (or installed or deployed) in the external server or the external electronic device. The electronic device 261 may offload, to the external server or the external electronic device, at least a portion of a task related to an AI function (e.g., image generation) generated by the electronic device 261. The external server or the external electronic device may perform at least a portion of the task related to the AI function generated by the electronic device 261 using the AI model 290. The external server or the external electronic device may transmit, to the electronic device 261, a result of the task (or a portion of the task) performed using the AI model 290. The electronic device 261 may receive the result of the task related to the AI function from the external server or the external electronic device. The electronic device 261 may perform the AI function based on the result of the task received from the external server or the external electronic device.

In the system 260, the method of performing the AI function by the electronic device 261 is not limited to the shown example. According to an embodiment, the electronic device 261 may include (or store) the AI model 290. The AI model 290 may be embedded (or installed or deployed) in the electronic device 261. The electronic device 261 may perform the AI function by on-device AI computing using the AI model 290 included in the electronic device 261. The electronic device 261 may perform the AI function using the AI model 290 (e.g., the LLM, the LVM, and the LVLM).

According to an embodiment, the system 260 may be a system based on the AI system 200 of FIG. 2. The system 260 may include at least a portion of the components of the AI system 200. For example, the electronic device 261 may be implemented as the user query/response interface 210.

In the system 260, the electronic device 261 may obtain data, such as an image, audio, a video, a voice, a call history, a message, a website visit history, a note, or sensor information. The electronic device 261 may obtain data based on a user input, such as capturing, recording, typing, drawing, or application manipulating. The electronic device 261 may receive the data from an external server (e.g., the server 108 of FIG. 1) or an external electronic device (e.g., the electronic device 102 or 104 of FIG. 1).

The electronic device 261 may receive (or obtain) the user input to the electronic device 261. The user input may include voice data corresponding to an utterance of the user, text data typed by the user, or touch input data to an icon, a button, an image, text, or various indicators obtained via a display of the electronic device.

The electronic device 261 may generate a prompt at least partially based on the user input to the electronic device 261. The prompt may include a natural language, text, a photo, a video, audio, or a combination thereof. According to an embodiment, the electronic device 261 may generate a prompt according to a template determined at least partially based on the user input. According to an embodiment, the electronic device 261 may generate the prompt at least partially based on the user input using the AI model 290.

The AI model 290 may generate output data based on the prompt. The output data may be a multimedia file including an element such as text, an image (e.g., a photo, a video), or graphics. The type of the output data generated by the AI model 290 and the meaning of generation are not limited to the described example, and for example, the AI model 290 may classify an image according to an instruction based on a prompt including images and an instruction (or a command) including text or may output a selected image.

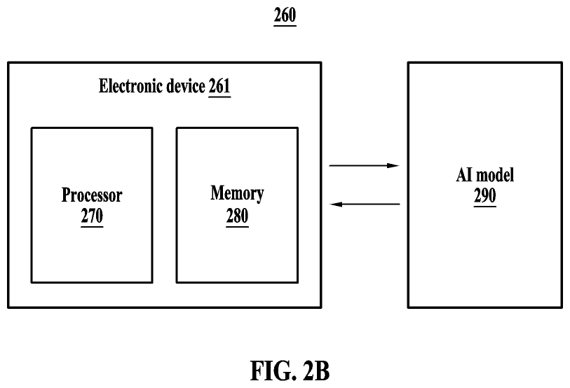

FIG. 3 is a flowchart of a method of outputting a target page, according to an embodiment.

Operations 310 to 360 may be performed by an electronic device (e.g., the electronic device 101 of FIG. 1 or the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

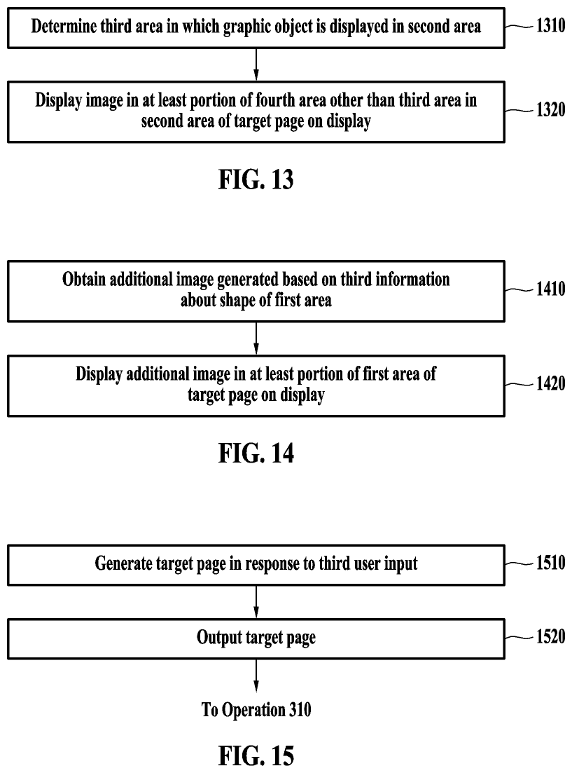

In operation 310, the electronic device may receive a first user input to a target page of a home screen of the electronic device. For example, the target page of the electronic device may be one of pages of the home screen displayed by a display (e.g., the display module 160 of FIG. 1). The target page may be an existing page or a new page generated in response to a user input (e.g., the “third user input” of the description with reference to FIG. 15). The first user input may include information about coordinates on the target page.

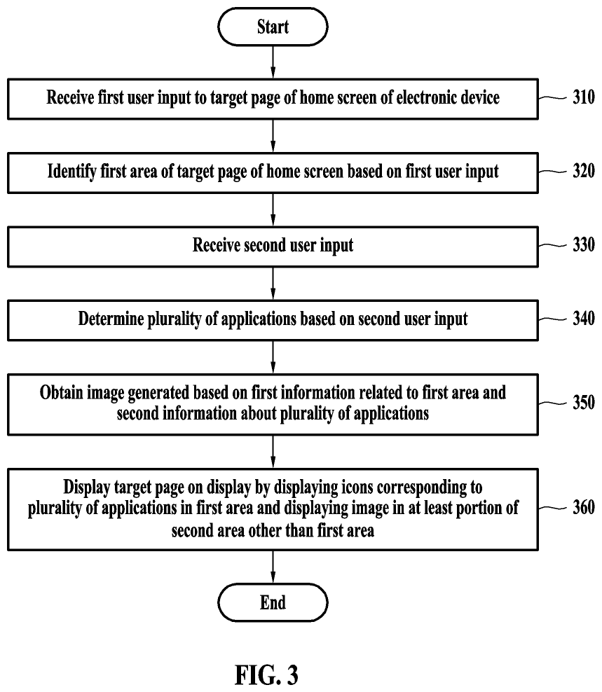

According to an embodiment, the user may use a hand or a user input device such as a digital pen to draw, for example, a closed path on the display of the electronic device where the target page is displayed, although in some embodiments different shapes than a closed path or other forms of user input based indication can be utilized. The display may receive the drawn closed path as the first user input using a touch sensor. The first user input is further described below with reference to FIG. 4A.

When a start position and an end position of the user touch correspond to each other, the closed path may be formed by moving positions between the start position and the end position. Even if the start position and the end position do not exactly correspond to each other, when a difference between the start position and the end position is within a predetermined range, it may be determined that the start position and the end position correspond to each other.

According to an embodiment, the display may display a plurality of grid cells forming the target page. The user may select one or more grid cells of the target page using the hand or the digital pen. The display may receive a selection input of the one or more grid cells as the first user input using the touch sensor. For example, the target page may include the plurality of grid cells. The shape and number of grid cells of the target page may vary depending on the size of the display and the shape of each grid cell and the number of grid cells.

In operation 320, the electronic device may identify a first area of the target page of the home screen in response to the first user input. For example, first grid cells corresponding to the first user input may be determined from the plurality of grid cells and the first area may be determined to include the first grid cells. The method of identifying the first area of the target page corresponding to the first user input is further described below with reference to FIG. 4A.

According to an embodiment, operation 320 may include determining a closed path designated by the first user input and identifying the first area including one or more first grid cells corresponding to the closed path.

In operation 330, the electronic device may receive a second user input. The second user input may be a text input, a sentence, or a keyword. For example, the second user input may designate a category of a plurality of applications to be displayed in the first area of the target page. The second user input may be used to determine the plurality of applications to be placed in the first area. For example, when the user desires to move applications related to movies in the first area, the electronic device may receive the text “movie” from the user as the second user input. For example, the second user input may indicate a category of an application. In this case, the term “application” may refer to not only a typical application but also a widget shown as a graphical UI (GUI) object.

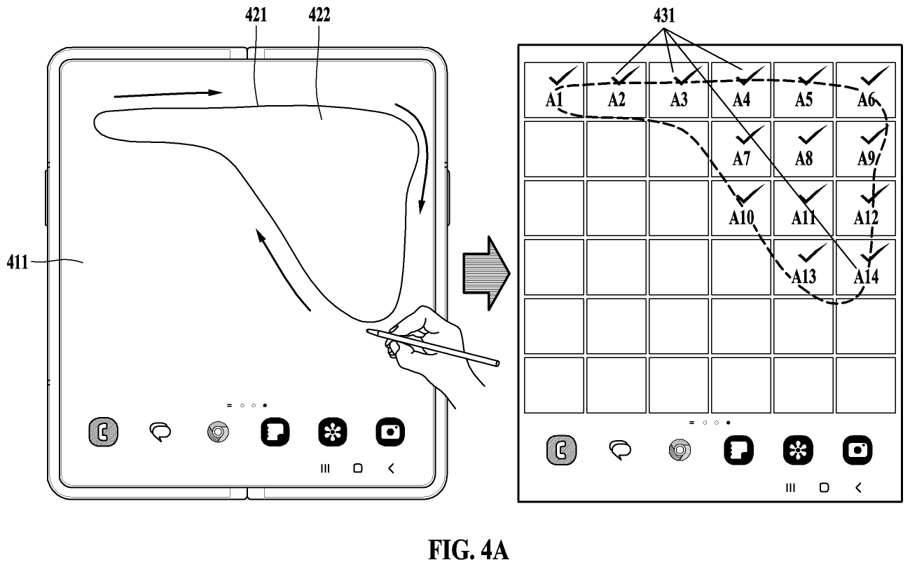

According to an embodiment, the second user input may be received using the first area. For example, the user may input the text “movie” in an area (e.g., the first area) shown by the closed path. The user may input the text, for example, via touch or input interfaces. When the user inputs a keyword using handwriting or the digital pen, the electronic device may recognize the text corresponding to the keyword using a text recognition model. For example, when the user touches the first area, the electronic device may output a UI object (e.g., a keyboard) for inputting text. The electronic device may receive the second user input using the UI object. The method of receiving the second user input is further described below with reference to FIGS. 5 to 7.

Although the embodiment in which the second user input is received using the hand or the digital pen is disclosed, the second user input may be received based on other user inputs, for example, a received voice and these examples are not limited to the described embodiments.

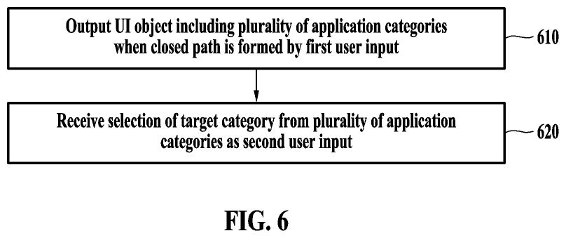

In operation 340, the electronic device may determine a plurality of applications corresponding to the second user input. For example, when the second user input is “movie”, applications related to movies may be determined. The electronic device may determine the plurality of applications by inputting the second user input to an AI model (e.g., the first model). The AI model may be a model trained to determine a plurality of applications corresponding to a prompt (e.g., the first prompt) based on the second user input. For example, the AI model may be included in the electronic device. For example, the AI model may be included in an external electronic device (e.g., the electronic device 102 or the server 108 of FIG. 1). The AI model may be an LLM, an LVM, or an LMM, and is not limited thereto. Hereinafter, the method of determining a plurality of applications corresponding to the second user input is further described with reference to FIG. 8.

According to an embodiment, determined one or more applications may include at least some of applications installed on the electronic device.

According to an embodiment, the determined one or more applications may include at least some of applications installed on the electronic device and applications that are not installed on the electronic device. The app that is not installed on the electronic device may be an app recommended to be installed. The recommended app may be determined based on the popularity, rating, and number of downloads of the app.

In operation 350, the electronic device may obtain an image generated based on first information related to the first area and second information about the plurality of applications. For example, the first information related to the first area may include information about the first grid cells. For example, the first information related to the first area may include information about a second area or second grid cells. For example, the second information about the plurality of applications may include at least one of a shape or color shown in icons corresponding to the plurality of applications.

The electronic device may obtain an image by inputting the first information related to the first area and the second information about the plurality of applications to an AI model (e.g., the second model). The AI model may be a model trained to generate an image corresponding to a prompt (e.g., the second prompt) based on the first information related to the first area and the second information about the plurality of applications. For example, the AI model may be included in the electronic device. For example, the AI model may be included in an external electronic device (e.g., the electronic device 102 or the server 108 of FIG. 1). The AI model may be an image generation AI model. The AI model may be an LLM, an LVM, or an LMM, and is not limited thereto.

According to an embodiment, the electronic device may receive a style of an image to be generated from the user and may generate a second prompt to include a keyword corresponding to the received style. The style of the image may include, for example, a watercolor style, an animation style, a pencil drawing style, a cartoon style, a three-dimensional (3D) neon style, and is not limited thereto.

According to an embodiment, the electronic device may receive, from the user, information about an object to be included in the image to be generated and may generate the second prompt to include a keyword corresponding to the received information about the object.

According to an embodiment, the electronic device may generate the second prompt to include information (e.g., area coordinates or an area size) about a second area. The image generated based on the information about the second area may have a size that may be placed in the second area.

In operation 360, the electronic device may display, on the display, the target page by displaying icons corresponding to the plurality of applications in the first area and displaying the image on at least a portion of the second area other than the first area.

The electronic device may display, on the display, the icons corresponding to the plurality of applications in the first area. For example, the icons corresponding to the plurality of applications may be arranged in the first grid cells of the first area.

According to an embodiment, the number of icons corresponding to the displayed applications may be determined based on the number of grid cells of the first area. For example, the number of displayed icons may be determined to be equal to or less than the number of first grid cells in the first area. When the number of determined applications exceeds the number of first grid cells, the number of displayed icons may be determined based on a priority of the plurality of applications. For example, the electronic device may determine the priority of the plurality of applications based on at least one of frequency of use, duration of use, and rating of the applications.

The electronic device may display the image in at least a portion of the second area other than the first area on the display. The image may be displayed using a layer. For example, the image may be placed in second grid cells of the second area. For example, when the size of the obtained image is larger than the second area, the electronic device may adjust the size of the image to be included in the second area. For example, when the size of the obtained image is larger than the second area, the electronic device may modify the image to show only some of objects included in the image and may place the modified image in the second area.

Since icons of applications related to the second user input may be displayed in the first area of the target page and an image related to the second user input or the plurality of applications is displayed in the second area, which is the remaining area, the target page with a consistent design may be provided to the user. The user may freely designate the first area, and thereby, a user experience different from what was previously provided may be provided to the user.

FIG. 4A illustrates a method of receiving a first user input and identifying a first area of a target page corresponding to the first user input, according to an embodiment, and FIG. 4B illustrates the first area of the target page and a second area determined based on the first area, according to an embodiment.

The user may draw a closed path 421 on a target page 411 output on a display (e.g., the display module 160 of FIG. 1) of an electronic device (e.g., the electronic device 101 of FIG. 1 and the electronic device 261 of FIG. 2B). The closed path 421 may include an inner area 422. The electronic device may receive the closed path 421 as a first user input.

The electronic device may identify a first area 431 based on a plurality of grid cells forming a target page 411. For example, when a proportion of the inner area 422 to the total area of a grid cell is equal to or greater than 30%, it may be determined that the grid cell is included in the first area 431. For example, the first area 431 may be identified to include first grid cells A1 to A14. For example, it may be determined that a corresponding grid cell is included in the first area 431 based on Rect class.

The electronic device may identify an area including remaining grid cells (e.g., second grid cells) other than the first area 431 from the plurality of grid cells forming the target page 411 as a second area 441.

FIG. 5 illustrates a method of receiving a second user input, according to an embodiment.

According to an embodiment, the user may input text 541 (e.g., a movie) or information corresponding to the text as the second user input to an inner area 531 shown by a closed path on a target page 511 output on a display (e.g., the display module 160 of FIG. 1) of an electronic device (e.g., the electronic device 101 of FIG. 1 and the electronic device 261 of FIG. 2B). The user may input the information into the electronic device using handwriting or a digital pen. The electronic device may receive the information received using a touch sensor as the second user input.

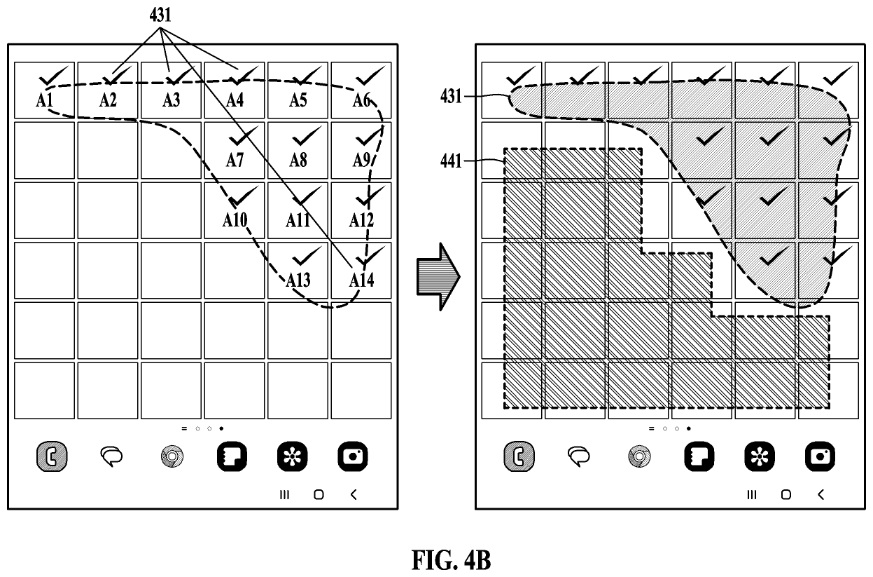

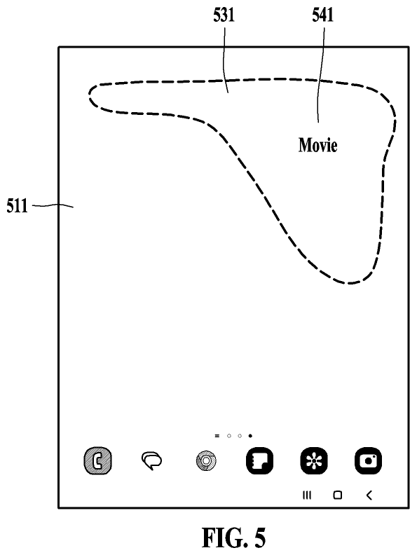

FIG. 6 is a flowchart of a method of receiving a second user input using a UI object, according to an embodiment, and FIG. 7 illustrates a method of outputting a UI object based on a first user input and receiving a second user input using the output UI object, according to an embodiment.

According to an embodiment, operations 610 and 620 may be associated with operation 330 described above with reference to FIG. 3. For example, operation 330 may include operations 610 and 620. Operations 610 and 620 may be performed by an electronic device (e.g., the electronic device 101 of FIG. 1 and the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

In operation 610, when a closed path 721 is formed by a first user input, the electronic device may output a UI object 731 including a plurality of application categories on a target page. For example, the UI object 731 may be output on the second area. For example, the UI object 731 may be output on at least a portion of the first area.

According to an embodiment, a reference position at which the UI object 731 is displayed may be determined based on an end position of the closed path 721. The reference position of the UI object 731 may be determined to show the UI object 731 around the end position of the closed path 721.

In operation 620, the electronic device may receive a selection of a target category from the plurality of application categories as the second user input. For example, the user may select movies from movies, productivity, health, education, and banking shown on the UI object 731. The electronic device may receive “movies” as the second user input.

According to an embodiment, the electronic device may display a received second user input 741 (e.g., movies) in the first area.

FIG. 8 is a flowchart of a method of obtaining a plurality of applications based on a first prompt generated based on a second user input, according to an embodiment.

According to an embodiment, operations 810 and 820 may be associated with, for example, operation 340 described above with reference to FIG. 3. For example, operation 340 may include operations 810 and 820. Operations 810 and 820 may be performed by an electronic device (e.g., the electronic device 101 of FIG. 1 and the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

In operation 810, the electronic device may generate a first prompt based on the second user input and information about a list of applications (application list information) installed on the electronic device. For example, the electronic device may generate a first prompt as an output in response to the second user input and an input of the information about the list of applications installed on the electronic device by using a prompt generation model. For example, the application list information may include at least one of an application package name, an application category, an application priority, and a frequency of use. For example, the first prompt may be in a Javascript object notation (JSON) format and is not limited thereto.

For example, the first prompt may be “Find 14 applications related to the second user input (e.g., “movies”) from applications in the application list based on the application priority using the application list information and provide application package names of the found applications”.

The first prompt may further include “If the number of applications related to the second user input is less than 14, provide a link to download an application related to the second user input (e.g., “movies”)”. In the above example, the number of applications, 14, may be determined based on the size of the first area. For example, the size of the first area may be proportional to the number of first grid cells. The first prompt may include the application list information.

In operation 820, the electronic device may obtain a plurality of applications corresponding to the first prompt in response to inputting the first prompt to a trained first model. For example, the first model may generate a list of application packages of the plurality of applications as an output in response to the input of the first prompt.

According to an embodiment, the electronic device may input the first prompt to the first model stored in the electronic device and may obtain the plurality of applications from the first model.

According to an embodiment, the electronic device may transmit the first prompt to an external electronic device (e.g., the electronic device 102, the electronic device 104, or the server 108) storing the first model and may receive, from the external electronic device, the plurality of applications determined by the first model of the external electronic device.

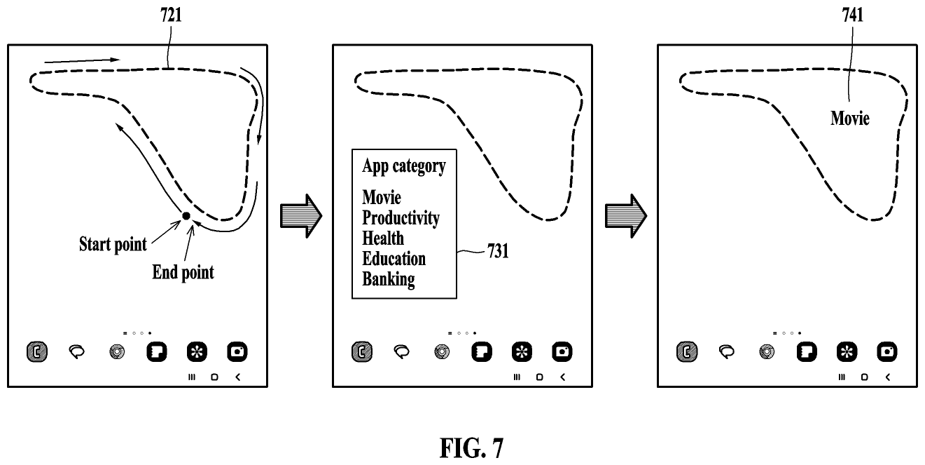

FIG. 9 illustrates a method of arranging icons corresponding to a plurality of applications in a first area, according to an embodiment.

An electronic device (e.g., the electronic device 101 of FIG. 1 and the electronic device 261 of FIG. 2B) may place a plurality of applications obtained based on the first model in the first area 431. The electronic device may place icons 901, 902, and 903 corresponding to the plurality of applications in the first area 431 based on the first grid cells of the first are 431. For example, the icons 901, 902, and 903 may be placed in the first area 431 such that one icon corresponds to each of the first grid cells. The placement positions (e.g., coordinates) of the icons 901, 902, and 903 may be determined based on the frequency of use of the plurality of applications.

According to an embodiment, the electronic device may modify at least one of the size, the shape, or the placement position of the displayed icons 901, 902, and 903 to correspond to the user's preference.

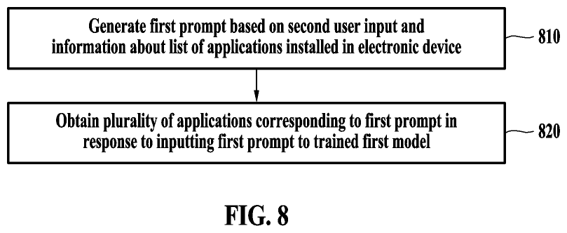

FIG. 10 is a flowchart of a method of obtaining an image based on a second prompt generated based on first information about a first area and second information about a plurality of applications, according to an embodiment.

According to an embodiment, operations 1010 and 1020 may be associated with, for example, operation 350 described above with reference to FIG. 3. For example, operation 350 may include operations 1010 and 1020. Operations 1010 and 1020 may be performed by an electronic device (e.g., the electronic device 101 of FIG. 1 and the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

In operation 1010, the electronic device may generate a second prompt based on first information related to the first area and second information about a plurality of applications. For example, the electronic device may generate the second prompt as an output in response to inputting the first information related to the first area and the second information about the plurality of applications. For example, the information about the plurality of applications may include at least one of a shape and a color shown in icons corresponding to the plurality of applications.

For example, the second prompt may be a prompt that requests to generate an image of an object described by the second user input. For example, the second prompt may be a prompt that requests to generate an image in a selected style from a plurality of styles. The electronic device may select a style prompt corresponding to a style determined by a user's selection from a plurality of style prompts and may generate the second prompt that requests to generate an image by combining the selected style prompt with the first information related to the first area and the second information about the plurality of applications. The second prompt may be a natural language sentence that combines a sentence about a style of an image to be generated and a sentence about an object of the image to be generated.

For example, the second prompt may appear as Table 1 below.

```
TABLE 1
  Create an image that fits the main
  keyword, consider the apps given as sub
keywords when creating the image, and
create an image that fits the given style.
  ### Style:
  - Art Style: Cartoonish and colorful.
  - Lines: Clean and bold outlines.
  - Colors: Vibrant and flat colors with minimal shading.
  - Mood: Fun and dynamic.
  - Size: 1100 × 600
  - Shape: rectangle, no images in the right corner
  ### Description:
  - Main Keyword: Movie
  - Sub Keyword: CGV, Netflix, YouTube, Videos, TVING, TV, ...
```

In operation 1020, the electronic device may obtain an image corresponding to the second prompt in response to inputting the second prompt to a trained second model. For example, the second model may generate an image as an output in response to the input of the second prompt.

According to an embodiment, the electronic device may input the second prompt to the second model stored in the electronic device and may obtain an image from the second model.

According to an embodiment, the electronic device may transmit the second prompt to an external electronic device (e.g., the electronic device 102, the electronic device 104, or the server 108) storing the second model and may receive, from the external electronic device, an image generated by the second model of the external electronic device.

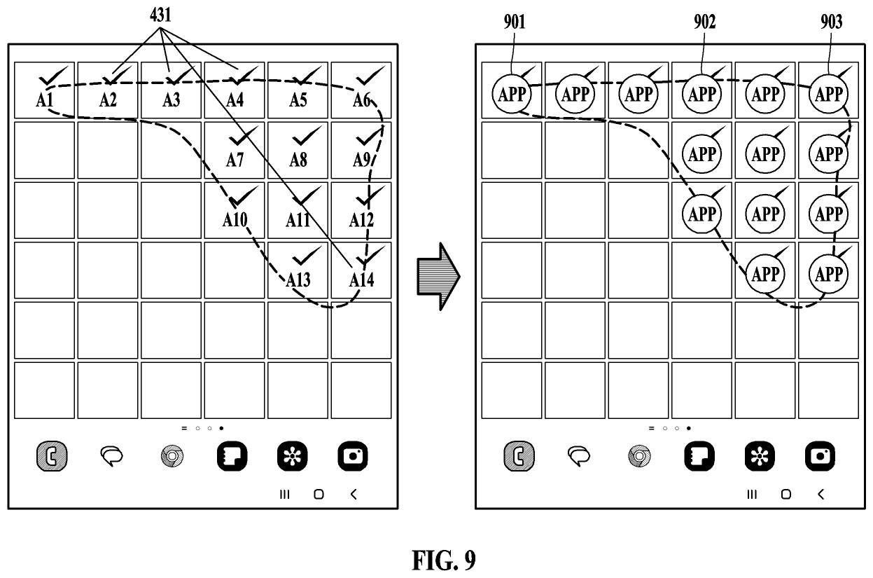

FIG. 11 illustrates a method of displaying a target page to include icons and images corresponding to a plurality of applications, according to an embodiment.

A target page output by a display (e.g., the display module 160 of FIG. 1) of an electronic device (e.g., the electronic device 101 of FIG. 1 and the electronic device 261 of FIG. 2B) may be divided into the first area 431 and the second area 441.

The electronic device may place an image 1101 generated by the second model in the second area 441. For example, when a size of an original image generated by the second model is greater than the size of the second area 441, the electronic device may generate the image 1101 by adjusting the size of the original image to correspond to the second area 441 and may place the image 1101 in the second area 441. For example, when the size of the original image generated by the second model is greater than the size of the second area 441, the electronic device may generate the image 1101 to include at least some of objects included in the original image and may place the image 1101 in the second area 441.

The electronic device may place, in the first area 431, at least some of icons 1111 corresponding to the plurality of applications obtained by the first model.

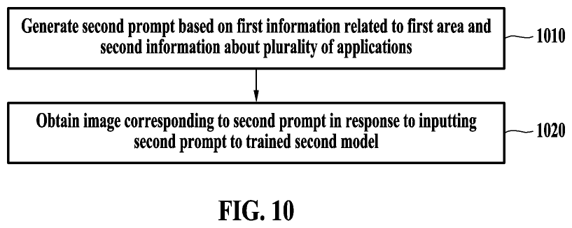

FIG. 12 is a flowchart of a method of displaying an image in a second area when a background image is set to a target page, according to an embodiment.

According to an embodiment, operations 1210 to 1230 may be associated with operation 360 described above with reference to FIG. 3. For example, operation 360 may include operations 1210 to 1230. Operations 1210 to 1230 may be performed by an electronic device (e.g., the electronic device 101 of FIG. 1 and the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

In operation 1210, the electronic device may determine whether a background image is set to a target page. For example, when the background image is set to at least a portion of the second area, the electronic device may determine that the background image is set to the target page.

In operation 1220, when the background image is set to the target page, the electronic device may cancel (or disable) the setting of the background image. For example, the setting of the background image may be canceled only for the target page.

In operation 1230, when the setting of the background image is canceled for the target page, the electronic device may display an image in at least a portion of the second area.

According to an embodiment, when the image is displayed in the second area, the electronic device may set a background color or a background image that does not interfere with identifying the image on the target page. The image may be output on the background color or the background image in the second area. For example, the background color or the background image may also be output on the first area. Icons may be output on the background color or the background image in the first area.

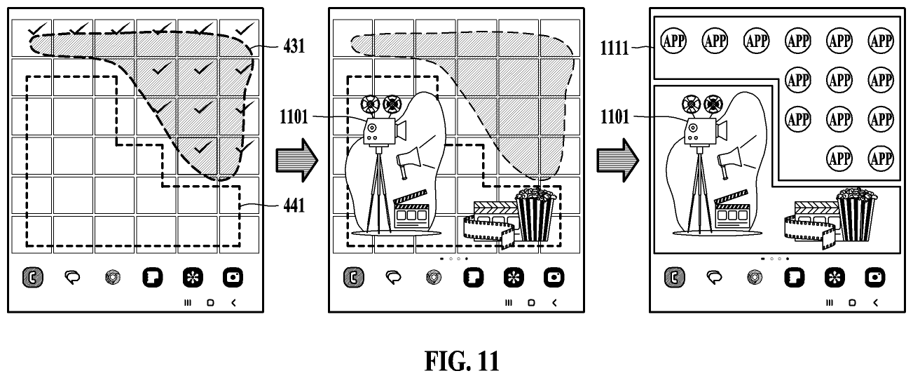

FIG. 13 is a flowchart of a method of displaying an image when a graphic object is displayed in a second area of a target page, according to an embodiment.

According to an embodiment, operations 1310 and 1320 may be associated with, for example, operation 360 described above with reference to FIG. 3. For example, operation 360 may include operations 1310 and 1320. Operations 1310 and 1320 may be performed by an electronic device (e.g., the electronic device 101 of FIG. 1 and the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

In operation 1310, the electronic device may determine a third area in which a graphic object is displayed in the second area of the target page. For example, the graphic object may be an object of a background image that is set to the target page. For example, third grid cells in which the graphic object is displayed may be determined from the second grid cells of the second area.

In operation 1320, the electronic device may display an image in at least a portion of a fourth area other than the third area in the second area of the target page, on the display. For example, the electronic device may place the image on remaining grid cells (e.g., fourth grid cells) other than the third grid cells from the second grid cells of the second area.

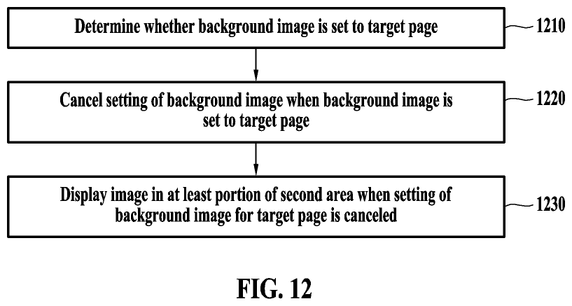

FIG. 14 is a flowchart of a method of displaying an additional image in a first area of a target page, according to an embodiment.

According to an embodiment, operations 1410 and 1420 may be associated with, for example, operation 360 described above with reference to FIG. 3. For example, operation 360 may include operations 1410 and 1420. For example, after operation 360 is performed, operations 1410 and 1420 may be additionally performed. Operations 1410 and 1420 may be performed by an electronic device (e.g., the electronic device 101 of FIG. 1 and the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

In operation 1410, the electronic device may obtain an additional image generated based on third information about a shape of the first area. For example, the third information about the shape of the first area may be information about the shape and the size of the closed path. For example, the third information about the shape of the first area may be information about the size of the first grid cells and the position in the target page.

According to an embodiment, the electronic device may obtain an image by inputting the third information about the shape of the first area to an AI model (e.g., a third model). The AI model may be a model trained to generate an image corresponding to a prompt (e.g., a third prompt) based on the third information about the shape of the first area. The third model may be the same model as the second model described above. For example, the AI model may be included in the electronic device. For example, the AI model may be included in an external electronic device (e.g., the electronic device 102 or the server 108 of FIG. 1).

According to an embodiment, when the shape of the first area is a shape of a figure, the obtained image may be an image of an object that may be expressed as the figure. For example, when the figure is a triangle, the generated image may be an image of a pyramid. For example, when the figure is a circle, the generated image may be an image of the moon.

FIG. 15 is a flowchart of a method of generating and outputting a target page, according to an embodiment.

According to an embodiment, operations 1510 and 1520 may be associated with, for example, operation 310 described above with reference to FIG. 3. For example, before operation 310 is performed, operations 1510 and 1520 may be performed in advance. Operations 1510 and 1520 may be performed by an electronic device (e.g., the electronic device 101 of FIG. 1 and the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

In operation 1510, the electronic device may generate a target page in response to a third user input. For example, the third user input may be a command to generate a target page via a menu. For example, the third user input may be a gesture input to generate a new page of a home screen. For example, the gesture input may be a screen swipe gesture input on a last page of the home screen and the gesture input is not limited thereto. The gesture input to generate a new page corresponding to the target page may be different from a gesture input to generate a new page using a default background image.

In operation 1520, the electronic device may output the generated target page. Operation 310 described above with reference to FIG. 3 may be performed on the output target page.

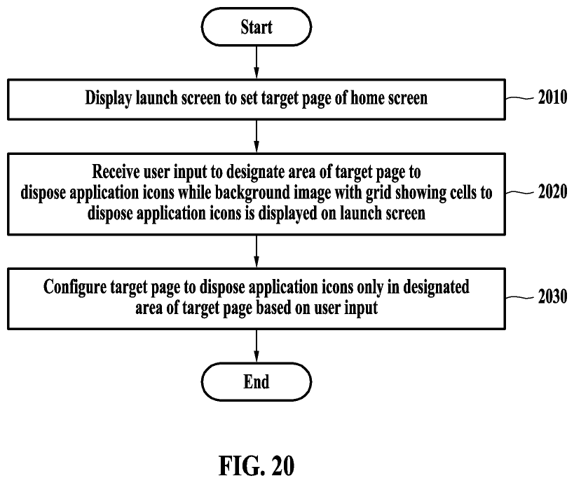

According to an embodiment, the electronic device may configure the target page based on a user input to designate an area of the target page to place application icons therein. Hereinafter, the method of configuring the target page is further described with reference to FIG. 20.

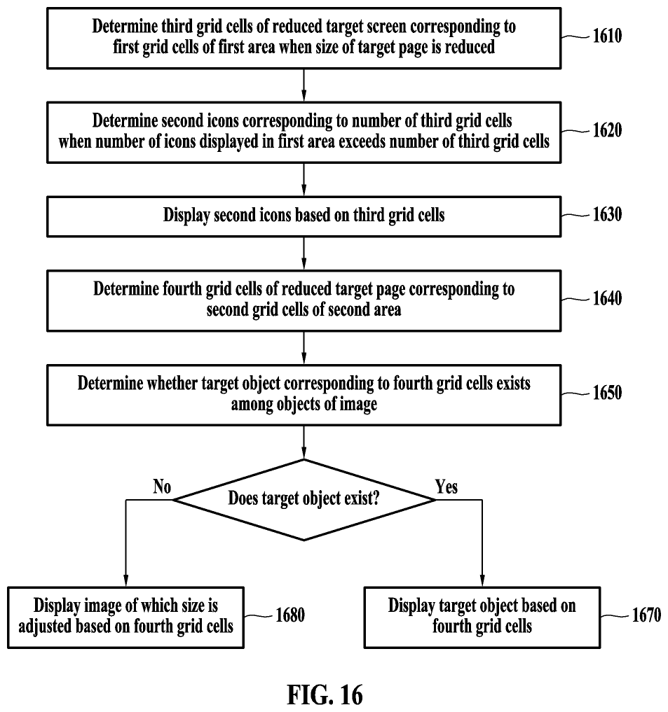

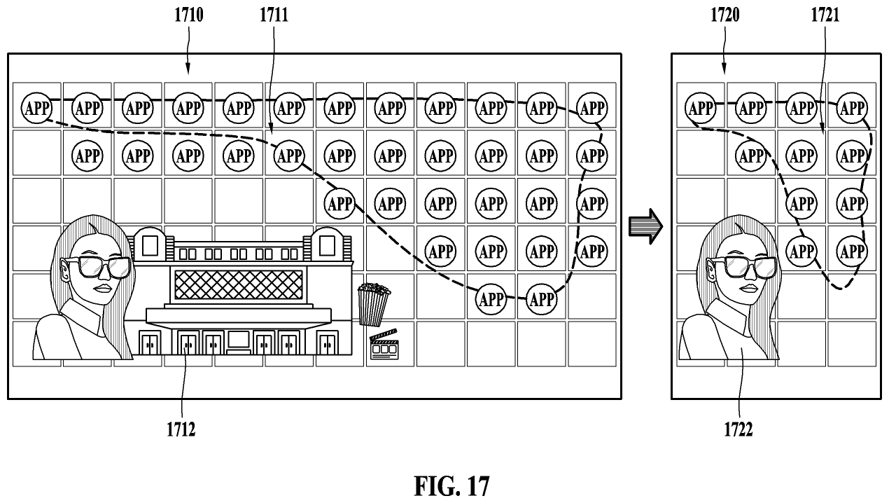

FIG. 16 is a flowchart of a method of displaying a target page when the size of the target page is reduced, according to an embodiment, and FIG. 17 illustrates a method of displaying a target page when the size of the target page is reduced from a first size to a second size, according to an embodiment.

According to an embodiment, operations 1610 to 1680 may be associated with operation 360 described above with reference to FIG. 3. For example, after operation 360 is performed, operations 1610 to 1680 may be performed. Operations 1610 to 1680 may be performed by an electronic device (e.g., the electronic device 101 of FIG. 1 and the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

In operation 1610, when a size of a target page 1710 is reduced, the electronic device may determine third grid cells 1721 of a reduced target page 1720 corresponding to first grid cells 1711 of the first area. When the size of the target page 1710 is changed from a first size to a second size, the third grid cells 1721 may be determined based on a ratio between the first size and the second size. For example, when the vertical size of the second size is the same as the vertical size of the first size and the horizontal size of the second size is ⅓ of the horizontal size of the first size, the third grid cells 1721 may be determined so that the number of cells placed in the vertical direction among the first grid cells 1711 remains or is reduced compared to before, and the number of cells placed in the horizontal direction among the first grid cells 1711 is reduced to ⅓ or less.

According to an embodiment, a single target page may be displayed using a plurality of displays and then the size of the target page may be reduced as some of the plurality of displays are disabled. For example, the electronic device may determine whether the size of the target page is reduced based on a state of a hinge that connects the plurality of displays.

In operation 1620, when the number of icons (e.g., the first icons) displayed in the first area exceeds the number of third grid cells 1721, the electronic device may determine second icons corresponding to the number of third grid cells 1721. For example, the electronic device may determine the second icons to correspond to the number of third grid cells 1721 from the first icons based on the application priority.

In operation 1630, the electronic device may display the second icons based on the third grid cells 1721.

In operation 1640, the electronic device may determine fourth grid cells of the reduced target page corresponding to the second grid cells of the second area. For example, the fourth grid cells may be grid cells other than third grid cells among the grid cells of the reduced target page.

In operation 1650, the electronic device may determine whether a target object corresponding to the fourth grid cells exists from objects of an image 1712. For example, an object that corresponds to the size of the fourth grid cells and is separable from other objects may be determined to be the target object. For example, even if the object corresponds to the size of the fourth grid cells, if the shape of the object is incomplete when the object is separated from other objects, the object may not be determined to be the target object.

If it is determined that the target object corresponding to the fourth grid cells exists from the objects of the image 1712, operation 1670 may not be performed and if not, operation 1680 may be performed.

In operation 1670, the electronic device may display the target object based on the fourth grid cells. For example, the electronic device may generate a second image 1722 based on the target object and may place the generated second image 1722 in the fourth grid cells.

In operation 1680, the electronic device may display an image of which the size is adjusted based on the fourth grid cells. For example, the electronic device may adjust the size of the image to correspond to the fourth grid cells and may place the image of which the size is adjusted in the fourth grid cells.

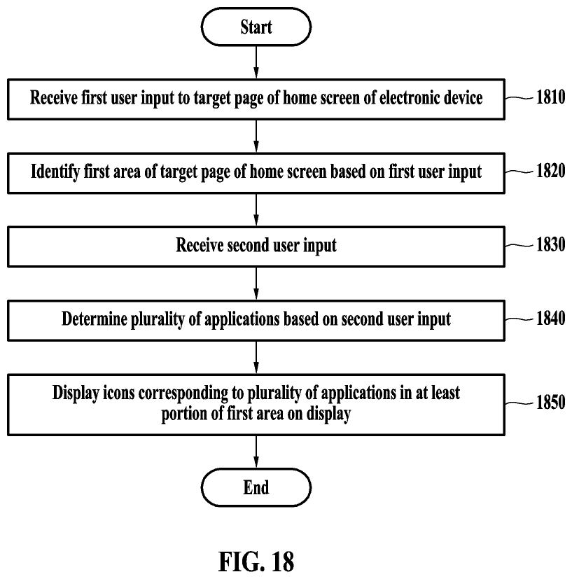

FIG. 18 is a flowchart of a method of displaying icons corresponding to a plurality of applications in a first area of a target page, according to an embodiment.

Operations 1810 to 1850 may be performed by an electronic device (e.g., the electronic device 101 of FIG. 1 and the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

In operation 1810, the electronic device may receive a first user input to a target page of a home screen of the electronic device. Since the description of operation 1810 may be replaced with the description of operation 310 provided above with reference to FIG. 3, hereinafter, a repeated description is omitted.

In operation 1820, the electronic device may identify the a first are of a target page of a home screen based on a received first user input. Since the description of operation 1820 may be replaced with the description of operation 320 provided above with reference to FIG. 3, hereinafter, a repeated description is omitted.

In operation 1830, the electronic device may receive a second user input. Since the description of operation 1830 may be replaced with the description of operation 330 provided above with reference to FIG. 3, hereinafter, a repeated description is omitted.

In operation 1840, the electronic device may determine a plurality of applications based on the second user input. Since the description of operation 1840 may be replaced with the description of operation 340 provided above with reference to FIG. 3, hereinafter, a repeated description is omitted.

In operation 1850, the electronic device may display icons corresponding to the plurality of applications on at least a portion of the first area, on the display. Since the description of operation 1850 may be replaced with the description of the method of displaying icons corresponding to the plurality of applications in the first area from the description of operation 360 provided above with reference to FIG. 3, hereinafter, a repeated description is omitted.

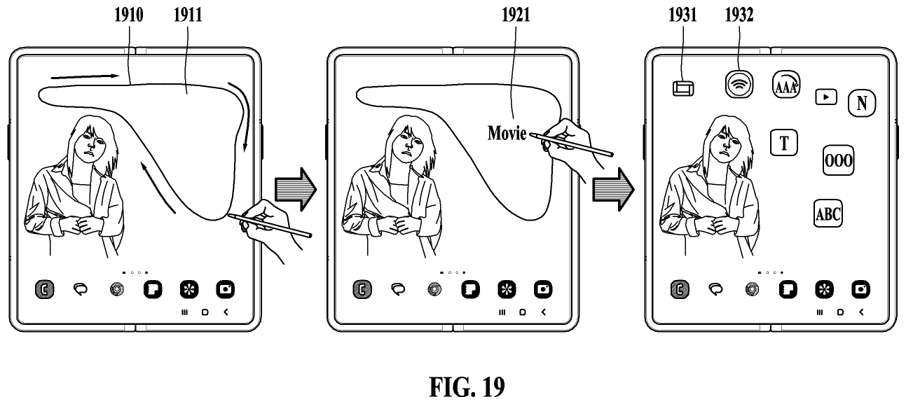

FIG. 19 illustrates a method of displaying icons corresponding to a plurality of applications in a first area of a target page, according to an embodiment.

The user may draw a closed path 1910 on a target page output on a display (e.g., the display module 160 of FIG. 1) of an electronic device (e.g., the electronic device 101 of FIG. 1 and the electronic device 261 of FIG. 2B). The closed path 1910 may include an inner area 1911. The electronic device may receive the closed path 1910 as a first input. According to an embodiment, a background image may be displayed on the target page and the user may draw the closed path 1910 so as not to overlap the background image.

The electronic device may identify a first area based on a plurality of grid cells forming the target page. For example, when a proportion of the inner area 1911 to the total area of a grid cell is equal to or greater than 30%, it may be determined that the grid cell is included in the first area.

According to an embodiment, the user may input text 1921 (e.g., movies) or information corresponding to the text as a second user input to the inner area 1911 shown by the closed path 1910 on the target page output on the display of the electronic device. The user may input the information into the electronic device using handwriting or a digital pen. The electronic device may receive the information received using a touch sensor as the second user input.

According to an embodiment, the electronic device may determine a plurality of applications corresponding to the received second user input and may display icons 1931 and 1932 corresponding to the plurality of applications in at least a portion of the first area, on the display.

According to an embodiment, the electronic device may determine whether at least one of the icons 1931 and 1932 overlaps an object (e.g., a foreground object) of the background image and is displayed. When an icon that overlaps the object of the background image and is displayed exists, the icon may be displayed behind the object of the background image. For example, at least a portion of the icon may be occluded by the object of the background image.

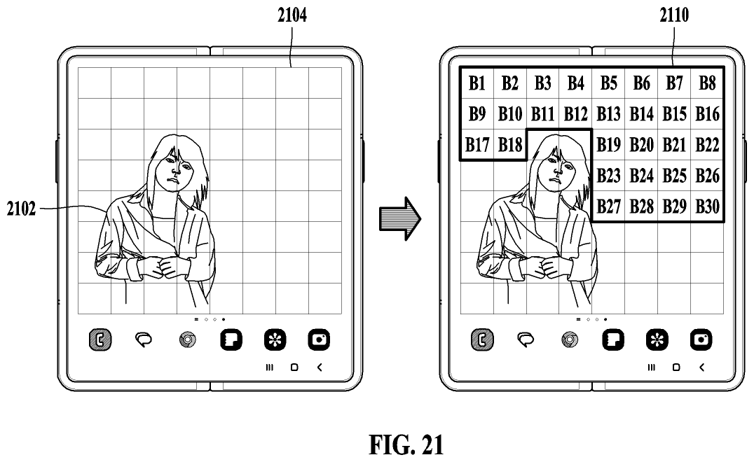

FIG. 20 illustrates a flowchart of a method of configuring a target page to arrange icons only in an area designated based on a user input, according to an embodiment, and FIG. 21 illustrates a method of configuring a target page to arrange icons only in an area designated based on a user input, according to an embodiment.

Operations 2010 to 2030 may be performed by an electronic device (e.g., the electronic device 101 of FIG. 1 and the electronic device 261 of FIG. 2B). For example, the electronic device may include at least one processor (e.g., the processor 120 of FIG. 1 or the processor 270 of FIG. 2B) and a memory (e.g., the memory 130 of FIG. 1 or the memory 280 of FIG. 2B).

According to an embodiment, operations 2010 to 2030 may be associated with, for example, operation 1510 described above with reference to FIG. 15. For example, operation 1510 may include operations 2010 to 2030.

In operation 2010, the electronic device may display a launch screen to set a target page of a home screen. For example, the launch screen may be displayed as one of functions provided to the user to switch an existing page of the home screen to the target page. For example, the launch screen may be displayed as one of functions provided to the user to generate a new page of the home screen as the target page.

According to an embodiment, a grid 2104 showing cells to place application icons thereon may be display on the launch screen. For example, when a background image (or a background object) 2102 is set on the target page, the background image 2102 may be further displayed on the launch screen.

In operation 2020, while the background image with the grid 2104 showing the cells to place the application icons is displayed on the launch screen, the electronic device may receive a user input to designate an area of the target page to place the application icons thereon. For example, the user may input selection information about at least some cells of the grid 2104 to the electronic device using a touch or a digital pen. The electronic device may receive the selection information as the user input using a touch sensor. For example, cells B1 to B30 may be selected from the cells of the grid 2104.

In operation 2030, the electronic device may configure the target page to place the application icons only in a designated area 2110 on the target page based on the user input.

According to an embodiment, the designated area 2110 may correspond to the first area described with reference to FIG. 3. For example, after operation 2030 is performed, operations 330 to 360 described with reference to FIG. 3 may be performed.

According to an embodiment, the determined icons of the plurality of applications may be displayed in the designated area 2110 based on the second user input and the target page may be output to display an image generated based on the information about the plurality of applications in at least a portion of the remaining area other than the designated area 2110. For example, the image may be displayed in at least a portion of the remaining area other than the designated area so that the image does not overlap the background image 2102.

According to an embodiment, the electronic device may obtain an additional image generated based on information about the shape of the designated are 2110. The electronic device may display the additional image in at least a portion of the designated area 2110 on the target page, on a display (e.g., the display 160 of FIG. 1).

According to an embodiment, the electronic device 101, 261 may include the display 160, at least one processor 120, 270 including processor circuitry, and the memory 130, 280 including one or more storage media storing instructions, wherein the instructions, when executed individually or collectively by the at least one processor 120, 270, may cause the electronic device 101, 261 to identify a first area of a target page of a home screen based on a first user input, determine a plurality of applications of icons to be displayed in the first area of the target page of the home screen based on a second user input, obtain an image generated based on first information related to the first area and second information about the plurality of applications, and display the target page on the display 160 by displaying the icons corresponding to the plurality of applications in the first area and the image in at least a portion of a second area other than the first area.

According to an embodiment, the instructions, when executed individually or collectively by the at least one processor 120, 270, may cause the electronic device 101, 261 to identify the first area including one or more first grid cells corresponding to a closed path designated by the first user input.

According to an embodiment, the second area may include second grid cells other than the one or more first grid cells among a plurality of grids of the target page.

According to an embodiment, the second user input may be received using the first area.

According to an embodiment, the instructions, when executed individually or collectively by the at least one processor 120, 270, may cause the electronic device 101, 261 to when the closed path is formed by the first user input, output a user interface (UI) object including a plurality of application categories, and receive a selection of a target category from the plurality of application categories as the second user input.

According to an embodiment, the instructions, when executed individually or collectively by the at least one processor 120, 270, may cause the electronic device 101, 261 to generate a first prompt based on the second user input and information about a list of applications installed on the electronic device 101, 261, and in response to inputting the first prompt to a trained first model, obtain the plurality of applications corresponding to the first prompt

According to an embodiment, the instructions, when executed individually or collectively by the at least one processor 120, 270, may cause the electronic device 101, 261 to generate a second prompt based on the first information related to the first area and the second information about the plurality of applications, and in response to inputting the second prompt to a trained second model, obtain the image corresponding to the second prompt.

According to an embodiment, the second information about the plurality of applications may include at least one of a shape and a color of the icons corresponding to the plurality of applications.

According to an embodiment, the instructions, when executed individually or collectively by the at least one processor 120, 270, may cause the electronic device 101, 261 to determine whether a background image is set to the target page, when the background image is set to the target page, cancel the setting of the background image, and when the setting of the background image for the target page is canceled, display the image in at least a portion of the second area.

According to an embodiment, the instructions, when executed individually or collectively by the at least one processor 120, 270, may cause the electronic device 101, 261 to generate the target page in response to a third user input, and output the target page.

According to an embodiment, the instructions, when executed individually or collectively by the at least one processor 120, 270, may cause the electronic device 101, 261 to obtain an additional image generated based on third information about a shape of the first area, and display the additional image in at least a portion of the first area of the target page, on the display 160.

According to an embodiment, the icons may be displayed on the additional image.

According to an embodiment, the instructions, when executed individually or collectively by the at least one processor 120, 270, may cause the electronic device 101, 261 to determine a third area in which a graphic object is displayed in the second area, and display the image in at least a portion of a fourth area other than the third area in the second area of the target page, on the display 160.

According to an embodiment, the method performed by the electronic device 101, 261 may include identifying 320 a first area of a target page of a home screen based on a first user input, determining 340 a plurality of applications of icons to be displayed in the first area of the target page of the home screen based on a second user input, obtaining 350 an image generated based on first information related to the first area and second information about the plurality of applications, and displaying 360 the target page on the display 160 by displaying the icons corresponding to the plurality of applications in the first area and the image in at least a portion of a second area other than the first area.

According to an embodiment, the identifying 320 of the first area may include determining a closed path designated by the first user input, and identifying the first area including one or more first grid cells corresponding to the closed path.

According to an embodiment, a non-transitory computer-readable storage medium storing instructions that, when executed by a processor, cause the processor to perform the method may be provided.

According to an embodiment, the electronic device 101, 261, may include the display 160, at least one processor 120, 270 including processor circuitry, and the memory 130, 280 including one or more storage media storing instructions, wherein the instructions, when executed individually or collectively by the at least one processor 120, 270, may cause the electronic device 101, 261 to identify a first area of a target page of a home screen based on a first user input, determine a plurality of applications of icons to be displayed in the first area of the target page of the home screen based on a second user input, and display the icons corresponding to the plurality of applications in at least a portion of the first area, on the display 160.

According to an embodiment, the instructions, when executed individually or collectively by the at least one processor 120, 270, may cause the electronic device 101, 261 to obtain an image generated based on first information related to the first area and second information about the plurality of applications, and display the image in at least a portion of the first area on the display 160.

According to an embodiment, the icons may be displayed on the image.

According to an embodiment, the second user input may be received using the first area.

According to an embodiment, the instructions, when executed individually or collectively by the at least one processor 120, 270, may cause the electronic device 101, 261 to when the closed path is formed by the first user input, output a UI object including a plurality of application categories, and receive a selection of a target category from the plurality of application categories as the second user input.

The embodiments described herein may be implemented using a hardware component, a software component and/or a combination thereof. For example, the device, the method, and the components described herein may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the embodiments described herein may be recorded in non-transitory computer-readable media including program instructions to implement various operations of the embodiments. The media may also include the program instructions, data files, data structures, and the like alone or in combination. The program instructions recorded on the media may be those specially designed and constructed for the embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. An electronic device, comprising:
a display;
at least one processor comprising processor circuitry; and
memory comprising one or more storage media storing instructions,
wherein the instructions, when executed individually or collectively by the at least one processor, cause the electronic device to:
identify a first area of a target page of a home screen based on a first user input,
determine a plurality of applications based on a second user input, each application associated with a corresponding icon to be displayed in the first area of the target page of the home screen,
obtain an image generated based on first information associated with the first area and second information associated with the plurality of applications, and
display a plurality of icons corresponding to the plurality of applications in the first area and the image in at least a portion of a second area distinct from the first area.

2. The electronic device of claim 1, wherein the instructions, when executed individually or collectively by the at least one processor, cause the electronic device to identify the first area comprising one or more first grid cells corresponding to a closed path designated by the first user input.

3. The electronic device of claim 2, wherein the second area comprises one or more second grid cells distinct from the one or more first grid cells.

4. The electronic device of claim 1, wherein the second user input is received in the first area.

5. The electronic device of claim 1, wherein the instructions, when executed individually or collectively by the at least one processor, cause the electronic device to:
when a closed path is formed by the first user input, display a user interface (UI) object comprising a plurality of application categories associated with a functionality of the plurality of applications, and
select a target category from the plurality of application categories based on the second user input.

6. The electronic device of claim 1, wherein the instructions, when executed individually or collectively by the at least one processor, cause the electronic device to:
generate a first prompt, based on the second user input and information associated with a list of applications installed on the electronic device,
input the first prompt to a first trained model, and
obtain, from the first trained model, the plurality of applications corresponding to the first prompt.

7. The electronic device of claim 6, wherein the instructions, when executed individually or collectively by the at least one processor, cause the electronic device to:
generate a second prompt, based on the first information associated with the first area and the second information associated with the plurality of applications,
input the second prompt to a second trained model, and
obtain, from the second trained model, the image corresponding to the second prompt.

8. The electronic device of claim 7, wherein the second information associated with the plurality of applications comprises at least one of a shape or a color of the icons of the plurality of applications.

9. The electronic device of claim 1, wherein the instructions, when executed individually or collectively by the at least one processor cause the electronic device to:
determine whether a background image is set to the target page,
when the background image is set to the target page, cancel setting of the background image to the target page, and
when the setting of the background image to the target page is canceled, display the image in at least a portion of the second area.

10. The electronic device of claim 1, wherein the instructions, when executed individually or collectively by the at least one processor, cause the electronic device to:
generate the target page in response to a third user input, and
display the target page.

11. The electronic device of claim 1, wherein the instructions, when executed individually or collectively by the at least one processor, cause the electronic device to:
obtain an additional image generated based on third information associated with a shape of the first area, and
display the additional image in at least a portion of the first area of the target page, on the display,
wherein the plurality of icons are displayed on the additional image.

12. The electronic device of claim 1, wherein the instructions, when executed individually or collectively by the at least one processor, cause the electronic device to:
determine a third area in which a graphic object is displayed in the second area, and
display the image in at least a portion of a fourth area distinct from the third area in the second area of the target page, on the display.

13. A method performed by an electronic device, the method comprising:
identifying a first area of a target page of a home screen based on a first user input;
determining a plurality of applications based on a second user input, each application associated with a corresponding icon to be displayed in the first area of the target page of the home screen;
obtaining an image generated based on first information associated with the first area and second information associated with the plurality of applications; and
displaying the target page on the display by displaying a plurality of icons corresponding to the plurality of applications in the first area and the image in at least a portion of a second area distinct from the first area.

14. The method of claim 13, wherein the identifying of the first area comprises:
determining a closed path designated by the first user input; and
identifying the first area comprising one or more first grid cells corresponding to the closed path designated by the first user input.

15. A non-transitory computer-readable storage medium storing instructions that, when executed by a processor, cause the processor to perform the method of claim 13.

16. An electronic device, comprising:
a display;
at least one processor comprising processor circuitry; and
memory comprising one or more storage media storing instructions,
wherein the instructions, when executed individually or collectively by the at least one processor, cause the electronic device to:
identify a first area of a target page of a home screen based on a first user input,
determine a plurality of applications based on a second user input, each application associated with a corresponding icon to be displayed in the first area of the target page of the home screen, and
display a plurality of icons corresponding to the plurality of applications in at least a portion of the first area, on the display.

17. The electronic device of claim 16, wherein the instructions, when executed individually or collectively by the at least one processor, cause the electronic device to:
obtain an image generated based on first information associated with the first area and second information associated with the plurality of applications, and
display the image in at least a portion of the first area.

18. The electronic device of claim 17, wherein the plurality of icons are displayed on the image.

19. The electronic device of claim 16, wherein the second user input is received in the first area.

20. The electronic device of claim 16, wherein the instructions, when executed individually or collectively by the at least one processor, cause the electronic device to:
when a closed path is formed by the first user input, display a user interface (UI) object comprising one or more application categories associated with a functionality of the plurality of applications, and
select a target category from the plurality of application categories based on the second user input.
